(19) United States
(12) Patent Application Publication
(10) Pub. No.: US 2009/0322613 A1
(43) Pub. Date: Dec. 31, 2009

(54) METHOD AND APPARATUS TO SUPPORT SINGLE USER (SU) AND MULTIUSER (MU) BEAMFORMING WITH ANTENNA ARRAY GROUPS

(75) Inventors: Erdem Bala, Farmingdale, NY (US); Philip J. Pietraski, Huntington Station, NY (US); Sung-Hyuk Shin, Northvale, NJ (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/493,552

(22) Filed: Jun. 29, 2009

Related U.S. Application Data
(60) Provisional application No. 61/076,977, filed on Jun. 30, 2008.

(51) Int. Cl. H01Q 3/00

(52) U.S. Cl. 342/373

(57) ABSTRACT

A method and apparatus are used to support single user (SU) and multiuser (MU) beamforming with antenna array groups. The method and apparatus are used to precode a plurality of data streams, beamform each of the data streams, and provide each of the beamformed data streams to one of a plurality of antenna array groups. An alternate method and apparatus are used to select a beamforming vector from a codebook, transmit a common reference signal (RS) based on the selection, receive an antenna configuration responsive to the common RS, estimate channels based on the antenna configuration, determine beamforming vectors for a plurality of antenna array groups, and transmit the beamforming vectors.

### CROSS REFERENCE TO RELATED APPLICATIONS

This application claims the benefit of U.S. provisional application No. 61/076,977 filed on Jun. 30, 2008, which is incorporated by reference as if fully set forth.

### TECHNOLOGY FIELD

This application is related to wireless communications.

### BACKGROUND

Beamforming is a multiple-input multiple-output (MIMO) technique used to provide array gain. It is mostly used in correlated channels where the antenna spacing is small and the angular spread at the base station (BS) is low. Under these conditions, the transmitter may form a directed beam towards the receiver.

Due to the high channel correlation, typical beamforming techniques are unable to efficiently provide diversity gain or spatial multiplexing gain. In addition, in advanced wireless systems such as Long Term Evolution (LTE)-Advanced (LTE-A), the number of transmit antennas is increased, for example up to 8 antennas in LTE-A, which enables various MIMO schemes like single-user (SU) MIMO or multi-user (MU) MIMO. In some cases, multiple transmit sites each having multiple antenna elements are employed for SU-MIMO or MU-MIMO transmission in a coordination manner. Therefore it would be desirable to have a method and apparatus to support single user and multiuser beamforming to efficiently provide diversity gain or spatial multiplexing gain.

### SUMMARY

A method and apparatus are used to support single user (SU) and multiuser (MU) beamforming with antenna array groups. The method and apparatus are used to precode a plurality of data streams, beamform each of the data streams, and provide each of the beamformed data streams to one of a plurality of antenna array groups. An alternate method and apparatus are used to select a beamforming vector from a codebook, transmit a common reference signal (CRS) based on the selection, receive an antenna configuration responsive to the common RS, estimate channels based on the antenna configuration, determine beamforming vectors for a plurality of antenna array groups, and transmit the beamforming vectors.

### BRIEF DESCRIPTION OF THE DRAWINGS

A more detailed understanding may be had from the following description, given by way of example in conjunction with the accompanying drawings wherein:

FIG. 1 is a diagram of a wireless communication system that supports single user (SU) and multiuser (MU) beamforming with antenna array groups;

FIG. 2 is a functional block diagram of the wireless transmit/receive unit (WTRU) and the evolved Node B (eNB) of the wireless communication system of FIG. 1;

FIG. 3 is a diagram of an architecture solution that supports single user and multi-user beamforming using antenna array groups;

FIG. 4 is a functional flow diagram of a eNB with two antenna array groups;

FIG. 5 is a flow diagram of a beamforming method;

FIG. 6 is a flow diagram of a method for transmitting to multiple users in spatial division multiple access (SDMA) mode;

FIG. 7 is a flow diagram of a method that employs non-codebook based beamforming; and

FIG. 8 is a functional flow diagram of an example system for beamforming control data.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, an eNB, a site controller, an access point (AP), or any other type of interfacing device capable of operating in a wireless environment.

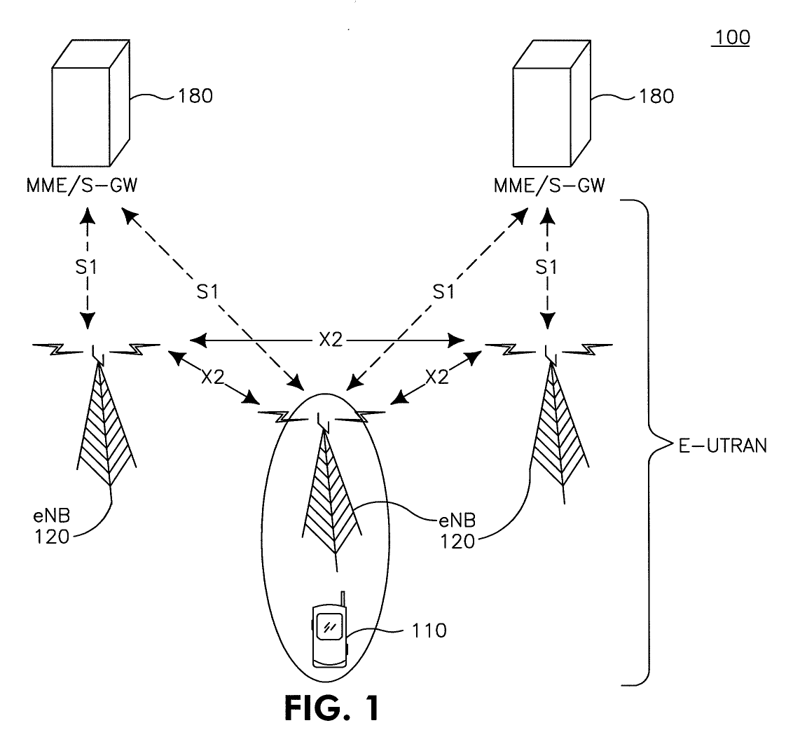

FIG. 1 is a diagram of a wireless communication system 100 that supports single user (SU) and multiuser (MU) beamforming with antenna array groups. FIG. 1 shows a wireless communication system/access network in LTE 100, which includes an Evolved-Universal Terrestrial Radio Access Network (E-UTRAN). The E-UTRAN as shown, includes a WTRU 110 and several eNBs 120. As shown in FIG. 1, the WTRU 110 is in communication with an eNB 120. The eNBs 120 interface with each other using an X2 interface. The eNBs 120 are also connected to a Mobility Management Entity (MME)/Serving GateWay (S-GW) 130, through an S1 interface. Although a single WTRU 110 and three eNBs 120 are shown in FIG. 1, it should be apparent that any combination of wireless and wired devices may be included in the wireless communication system 100.

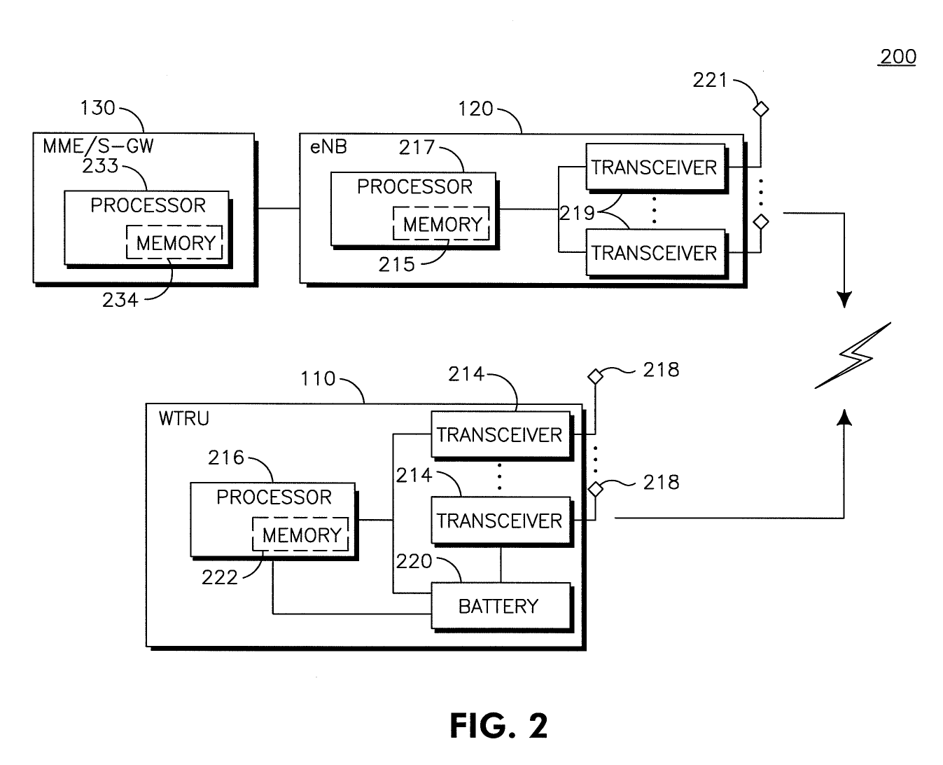

FIG. 2 is an example block diagram 200 of the WTRU 110, the eNB 120, and the MME/S-GW 130 of wireless communication system 100 of FIG. 1. As shown in FIG. 2, the WTRU 110, the eNB 120 and the MME/S-GW 130 are configured to support SU and MU beamforming with antenna array groups.

In addition to the components that may be found in a typical WTRU, the WTRU 110 includes a processor 216 with an optional linked memory 222, a transmitter and receiver together designated as a transceiver 214, an optional battery 221, and a group of antennas 218 that form an antenna array group. The processor 216 is configured to support SU and MU beamforming with antenna array groups. The transceivers 214 are in communication with the processor 216 and antennas 218 to facilitate the transmission and reception of wireless communications. In case a battery 220 is used in WTRU 110, it powers the transceivers 214 and the processor 216.

In addition to the components that may be found in a typical eNB, the eNB 120 includes a processor 217 with an optional linked memory 215, transceivers 219, and a group of antennas 221 that form an antenna array group. The processor 217 is configured to support SU and MU beamforming with antenna array groups. The transceivers 219 are in communication with the processor 217 and antennas 221 to facilitate the transmission and reception of wireless communications. The eNB 120 is connected to the Mobility Management Entity/Serving GateWay (MME/S-GW) 130 which includes a processor 233 with a optional linked memory 234.

One possible method to support both beamforming and spatial multiplexing/diversity is to use more than one antenna array where the correlation between the arrays is small. In such configuration, several beams may be created on each antenna array and one layer of data may be transmitted on each beam. These layers may be encoded to support certain MIMO schemes such as spatial multiplexing or diversity. In the following discussion, without losing generality, certain examples are given for two layers of data, i.e., dual layer beamforming.

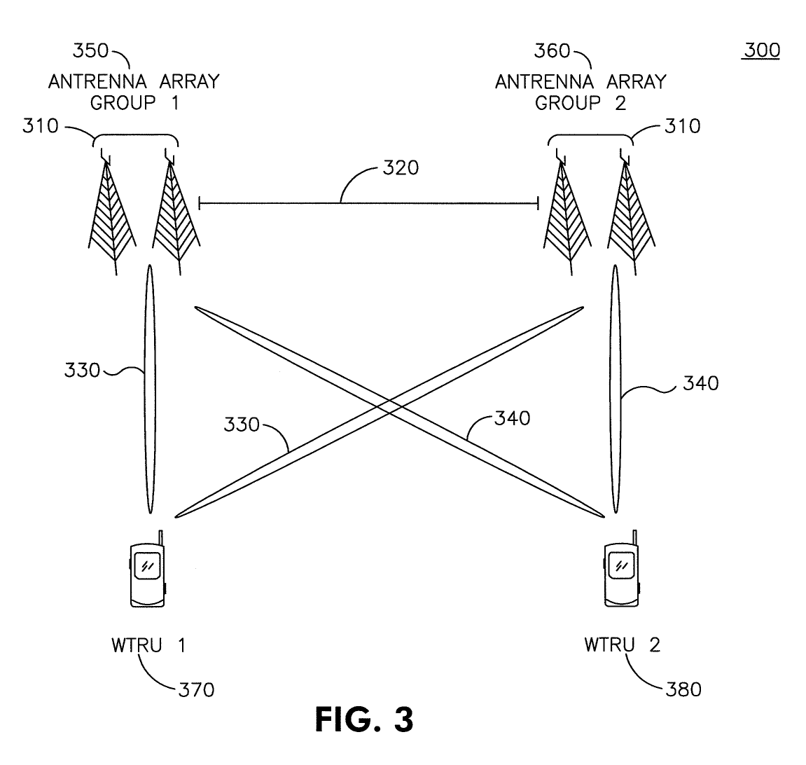

FIG. 3 is a diagram of an architecture 300 solution that supports single user and multi-user beamforming using antenna array groups, where each antenna array group consists of closely spaced antennas and different groups are separated with a larger spacing. For example, there may be two groups of 4 antennas (or antenna ports). Within each antenna array group the spacing between the antennas 310 is small, for example, ½ carrier wavelength, but each group is separated by a large distance 320, for example, different towers that may be 100s or 1000s of wavelength away. This spacing ensures that the correlation between the antenna groups is small due to large spacing, but that correlation between antennas in the same group may be quite high. In another example, antenna groups might be created by using different polarizations for the groups, for example horizontal/vertical polarization, Sine/Cosine wave polarization, or the like. In this example architecture, it is possible to form different beams 330, 340 via the antenna array groups and multiple input multiple output (MIMO) techniques such as space time/frequency coding, spatial multiplexing, etc. may be applied on these beams.

As shown in FIG. 3, the two antenna array groups 350, 360 may be used to form beams to two WTRUs 370, 380. The antenna array groups may be on the same eNB, or they may be on different eNBs.

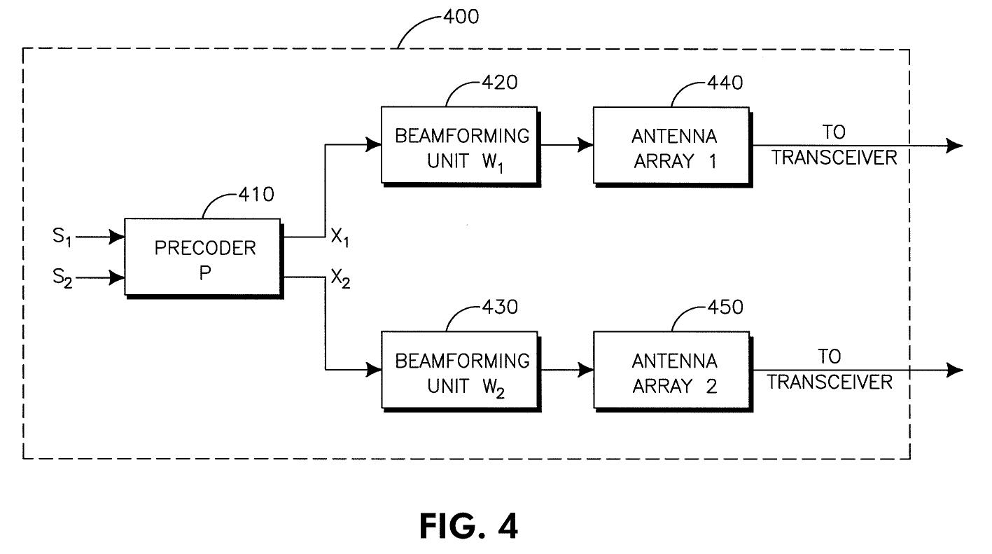

FIG. 4 is a functional flow diagram of a processor 400 that may be included in the WTRU 110 and eNB 120 shown in FIGS. 1 and 2. The processor 400 includes a precoder P 410, a first beamforming unit w₁ 420, a second beamforming unit w₂ 430, a first antenna array group 440, and a second antenna array group 450. Although it is assumed in the following example that there are two antenna array groups, this is for illustration purposes only and the proposed methods may similarly be applied to any other setting. In accordance with the example shown in FIG. 4, the data streams s₁ and s₂ are precoded at the precoder P 410 such that S₁ and S₂ may be for a single WTRU or for two different WTRUs. The precoding operation may be any precoding operation, for example, space time/frequency block coding, precoding for spatial multiplexing, or any other type of precoding. The resultant streams X₁ and X₂ are forwarded to a first beamforming unit w₁ 420 and a second beamforming unit w₂ 430, respectively, and antenna beams are formed using appropriate beamforming vectors. The resulting beamformed streams are forwarded to a first antenna array 440 and a second antenna array 450, respectively.

In a MIMO orthogonal frequency division multiple access (OFDMA) system, different beamforming vectors may be applied on different frequency groups (frequency selective beamforming), or the same beamforming vector may be used over the whole frequency band (wideband beamforming).

In a first embodiment, a codebook may contain predetermined beamforming vectors that may be used to implement beamforming. For example, a WTRU selects the best vectors from the codebook and feeds this information to the eNB. The selected vectors are then used by the eNB for data transmission.

The beamforming vectors used on the first antenna array group 440 and the second antenna array group 450 are denoted by w₁ and w₂, respectively, and the channels from the antenna array groups to the receiver are given by the matrices H₁ and H₂, respectively. The received signal, then, may be written as

r=H₁w₁x₁+H₂w₂x₂. Equation (1)

To optimize the performance, the beamforming vectors may be selected such that the received SINR is maximized.

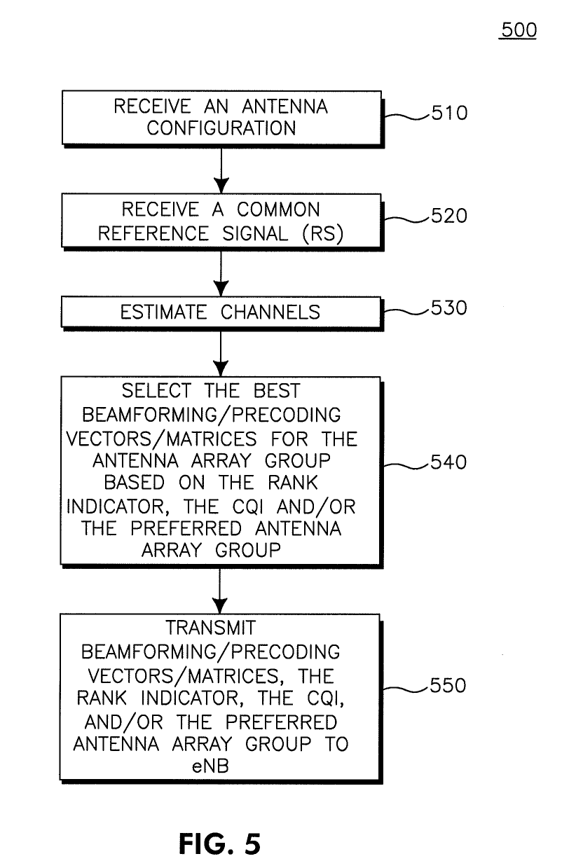

FIG. 5 is a flow diagram of a beamforming method. When using a codebook in accordance with this method for beamforming, one beamforming vector per beam may be selected from a codebook that comprises of rank-1 vectors, i.e. each vector is of the dimension (Nₜ×1) where Nₜ is the number of transmit antennas.

An antenna configuration may be received 510 from the eNB, for example in the broadcast channel (BCH), and is therefore known by the WTRUs. Not all antenna array groups are required to transmit data to a given WTRU. In such a case, the antenna array group to be used may be configured semi-statistically, or selected by the WTRU dynamically. The WTRU may signal the index of the antenna array group it prefers and the corresponding beamforming vector. In this example, the WTRU indication of a preferred group would be an option of the network, but if the network elected to use it, it would be required by the WTRU to support it. This would be useful, for example, when the channel from an antenna group is of poor quality and transmitting from that group would result in a waste of power. If the WTRU has supplied enough information to notify the network that the use of certain groups would not significantly increase the resource requirement for the particular WTRU, the network would prefer not to use the power and/or radio resources that it could then use for another WTRU. An example where the WTRU indicates the preferred group(s) is one such method. Other methods like signal-to-interference ratio (SIR) or channel quality indicator (CQI)-like reporting may also be used. Alternatively, all power may be used to transmit from the selected antenna group.

Common reference signals (CRSs) are received 520 from the network infrastructure nodes on reserved subcarriers as part of the downlink transmitted signal. CRSs may be transmitted from all antenna ports in a group or from some of the antennas. For example, there may be one CRS per antenna group. Furthermore, multiple physical antennas may comprise a single antenna port. Transmitting the CRS from each antenna reduces the spectral efficiency because it requires more subcarriers to be reserved. To reduce the overhead, CRSs from different antenna ports may be multiplexed in time. For example, CRSs from antennas 1 and 2 may be transmitted in subframe k, and CRSs from antennas 3 and 4 may be transmitted in the next subframe. CRSs from different antenna array groups may be multiplexed in frequency and/or time. Additionally, they may be transmitted on the same subcarriers by using orthogonal codes.

By using the CRS, the WTRU estimates 530 the channel matrices H₁ and H₂ and selects 540 the preferred beamforming vector for each of the antenna array groups, the preferred precoding matrix, a rank indicator, a CQI and/or a preferred antenna array group. The selection for the beamforming vectors may be fed back 550 to the eNB with 2 log₂(M) bits, where M is the size of the codebook that is being used. The composition of the codebook is dependent upon the number of antennas in the antenna array group. If each antenna array group comprises a different number of antennas, then a different codebook must be used for each group. Accordingly, the signaling overhead becomes log₂(M₁)+log₂(M₂) where M₁ and M₂ are the sizes of the codebooks for the 1^{st} and 2^{nd} antenna array groups, respectively.

As an alternative, the codebook may comprise unitary or non-unitary matrices where each column of a matrix corresponds to a beamforming vector to be used for the corresponding antenna array group. A unitary matrix is a matrix such that the columns are orthogonal to each other and the U^{H}U=I where H denotes the conjugate transpose operation and I is the identity matrix. In this alternative, the WTRU feeds back the index of the beamforming matrix only. The signaling overhead is log₂(N) where N is the number of matrices.

Where the codebook comprises matrices W=[w₁ w₂], then the ordering of the columns is also important and the WTRU must signal this order. For example, in one alternative, w₁ may be used for the first antenna array group and in another alternative it may be used for the second antenna array group.

In a second embodiment, rank adaptation in the antenna array groups to increase the system capacity by spatial multiplexing or link reliability by space time/frequency block coding may be used. To select the proper method, the WTRU may also feed back the rank indicator to the eNB. If the rank indication is larger than one, then the eNB may effectively use spatial multiplexing with precoding. Precoding is applied to the data streams such that x=Ps. In the special case when P is equal to the identity matrix, each data stream/layer is transmitted from the corresponding antenna array group via the corresponding beam. When the rank is one, the same data stream/layer is transmitted on the beams. Alternatively, when the rank is one, the WTRU (or eNB) may select one of the antenna groups (i.e., antenna group selection).

The preferred precoding matrix P may also be fed back from the WTRU to the eNB. To achieve this, another codebook may be employed and the WTRU selects the appropriate precoding matrix from this codebook. This requires an additional signaling overhead of log₂(L) bits, where L is the size of this codebook. The transmitted signal may be written as x=WPs where W is the codebook for beamforming and P is for precoding. P may be used to improve performance further. For example, if there are four antenna groups, this would be analogous to having four antenna ports. P may be used for optimization over these four antenna ports.

When the rank is one, the eNB may also use space time/frequency block coding and/or cyclic delay diversity (CDD). For example, if Alamouti based space frequency coding is used, the symbols to be transmitted may be written as

$$[ \begin{matrix}{x}_{1 , i} & {x}_{1 , i + 1} \\ {x}_{2 , i} & {x}_{2 , i + 1}\end{matrix} ] = [ \begin{matrix}{s}_{1} & {s}_{2} \\ - {s}_{2}^{*} & {s}_{1}^{*}\end{matrix} ] \qquad Equation ( 2 )$$

where x_{m,n} denotes the symbol to be transmitted from the m'th antenna group on the n'th subcarrier. In this example, all antenna array groups are used for transmission. Alternatively, when the rank is one, the WTRU (or eNB) may select one of the antenna groups (i.e., antenna group selection).

In a third embodiment, precoding performance may be improved by combining precoding with large delay CDD. In this example, consecutive symbols from the different data streams/layers are transmitted on different beams in a cyclical manner. For example, on subcarrier i, a symbol of layer x₁ is transmitted from beam 1 and a symbol of layer x₂ is transmitted from beam 2; on the next subcarrier, a symbol of layer x₁ is transmitted from beam 2, and a symbol of layer x₂ is transmitted from beam 1. This is similar to layer permutation. Layer permutation refers to MIMO transmission techniques wherein the multiple spatial channels used in a transmission with multiple data streams are shared by each data stream. In this way, the average channel conditions, such as quality, are on average about the same for each stream. It is understood that the data streams/layers transmitted on different beams do not have to be cyclic, consecutive, or organized in any particular way. With large delay CDD, the effective precoding may be written as P=PoDU where Po is the precoding matrix, D is the CDD matrix, and U is designed such that large delay CDD is supported.

For two antenna array groups (which is also equal to the number of maximum streams per WTRU), and four transmit antennas per group, these matrices may be reused as:

$$U = [ \begin{matrix}1 & 1 \\ 1 & {e}^{- j2π / 2}\end{matrix} ]$$

$${D}_{i} = [ \begin{matrix}1 & 0 \\ 0 & {e}^{- j2π i / 2}\end{matrix} ] ,$$

where “i” denotes the subcarrier index.

Alternatively, small delay CDD may be used. Contrary to large delay CDD, small delay CDD does not result in layer permutation, When small delay CDD is used,

$${D}_{i} = [ \begin{matrix}1 & 0 \\ 0 & {e}^{- j 2 π \cdot i \cdot δ}\end{matrix} ] ,$$

where δ is a constant that defines the amount of delay.

Layer permutation may also be implemented as discussed above, by simply transmitting a symbol from one data layer over all spatial channels consecutively. Note that the symbol may be a modulation symbol or a single or a set of orthogonal frequency division multiplexing (OFDM) symbols.

In a fourth embodiment, an appropriate SU-MIMO codebook may be used as the beamforming codebook to create commonality among different kinds of MIMO techniques in the LTE system. For example, if each antenna group comprises four antennas and there are two antenna array groups, then the appropriate part of the SU-MIMO codebook (that comprises 4×2 or 2×4 matrices depending on the construction of the codebook) may be used as the beamforming codebook. It is also possible to use a subset of these codebooks.

Alternatively, a different codebook may be used than the one used in the current LTE system where the codebook comprises unitary matrices W=[w₁ w₂]. In another alternative, a SU-MIMO rank-1 codebook of the current LTE system may be used as a starting point to design the larger rank codebook elements, using linear combinations of the vectors from the rank-1 codebook. The codebook may also be designed by creating unitary or non-unitary matrices with all or some of the possible 2-combinations of orthogonal vectors from the rank-1 codebook.

The codebook may include vectors instead of matrices and the same codebook may be used for all antenna array groups. For example, the rank-1 SU-MIMO codebook or a subset of this codebook may be used for each antenna array group. Accordingly, for each antenna array group, the WTRU signals the index of the preferred beamforming vector. This requires m*log₂(M) bits, where m is the number of antenna array groups and M is the size of the codebook. For example, the codebook may be created from vectors taken from a Fast Fourier Transform (FFT) matrix. The first 4 rows of an 8×8 FFT matrix may be used to create a codebook for 4 transmit antennas with 8 beamforming vectors. This codebook is equivalent to a codebook that consists of M^{m} matrices. The signaling overhead may be reduced by using a subset of the all possible matrices. Similarly, the 2 Tx SU-MIMO codebook of the current LTE system may be used as the codebook for the precoding matrix Po.

A precoder selection made by the WTRU may be verified or the index of the used beamforming matrix or the indices of the beamforming vectors may be explicitly signaled. Explicit signaling may be employed when, for example, the eNB decides to override the WTRU decision. Explicit signaling may also be employed for the precoding matrix P. Alternatively, dedicated RSs may be used to signal the beamforming vectors. One dedicated RS is required per antenna array group. For example, the dedicated RSs may be multiplexed over different subcarriers or the RSs may be multiplexed over the same resources using orthogonal codes.

When using dedicated RSs, a known reference signal is multiplied by the beamforming vector and each element of the result is transmitted from one of the transmit antennas, i.e., the RSs propagate through the same effective channel as the data since beamforming is applied to them in the same way. Alternatively, it is possible to transmit the dedicated RS from one or some of the antennas in a group if the phases and amplitudes of the channels from different antennas are similar. All of the physical antennas for an antenna port may be used except when the phases and amplitudes of the channels from different antennas are similar.

When frequency selective beamforming is used, sending the beamforming matrix indications in the control channel may result in a variable control channel size. To overcome this problem, the control channel format may be designed such that the maximum control channel size is supported. Different dedicated RSs may be used for each transmission band on which a different beamforming vector may also be used. Then, a confirmation may be sent to the WTRU to confirm the beamforming vectors selected by the WTRU. In a wideband beamforming example, the same beamforming vectors are used for all allocated resource block groups (RBGs). As such, either the control channel or dedicated RSs may be used.

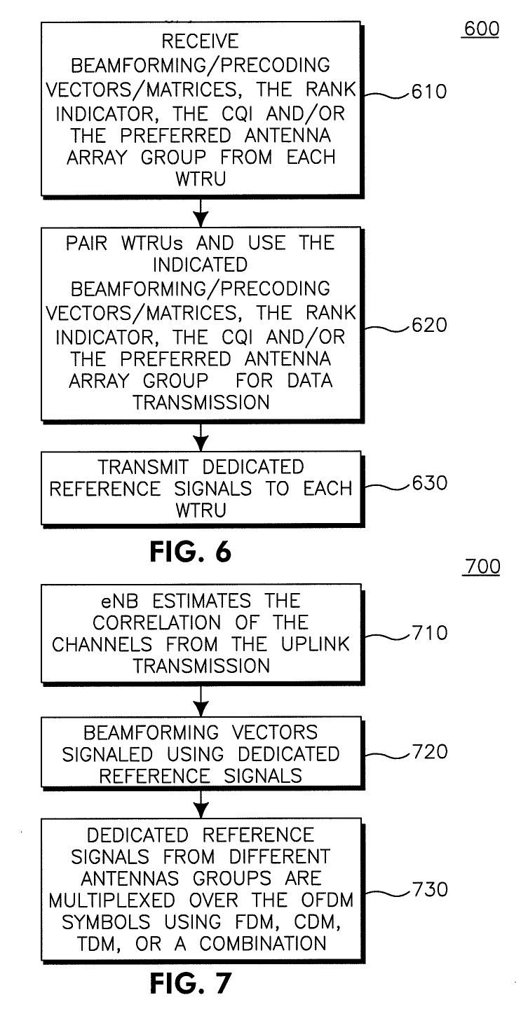

FIG. 6 is a flow diagram of a fifth embodiment that supports transmission to multiple users in spatial division multiple access (SDMA) mode. In this embodiment, one beam per WTRU is transmitted from each antenna array group.

When multiple WTRUs are multiplexed in the space domain, the same design issues as for the single user case are considered. In MU-MIMO communications, each WTRU independently selects the beamforming/precoding vectors/matrices, a rank indicator, and/or preferred antenna array, and signals the selection to the eNB with the CQI 610. The eNB scheduler then pairs the WTRUs, uses the indicated beamforming/precoding vectors/matrices for data transmission 620 and transmits dedicated RSs to each WTRU 630. The pairing of the WTRUs may be based on, for example, the preferred beamforming matrices, CQI, the power used for each WTRU, or any other similar factor. The eNB may also override the WTRU selection and use different beamforming vectors than those reported. The WTRU selected beams may be overridden, for example, to reduce interference to some other WTRU. The dedicated RSs transmitted to each WTRU may be orthogonal.

In accordance with this method, for MU-MIMO communications, the downlink control signaling due to the existence of an interfering WTRU is different than in the single user case. The eNB may choose to signal the beamforming matrix used for the interfering WTRU or not. This choice may be based on, for example, the need to reduce overhead signaling, where the eNB may not send all the information about the MU-MIMO beams to all WTRUs. If the beamforming matrix used for the interfering WTRU is signaled, then the WTRU may try to reduce the interference via an appropriate receive processing. One example of appropriate receive processing may be Multi-User Detection.

The eNB may pair possibly different WTRUs on different (non-contiguous) frequency bands and use the indicated beamforming matrices for data transmission. If different beamforming matrices are used for these WTRUs, then signaling the interfering beamforming matrices may result in a large overhead. In this case, there are several options that may be selected based on design preferences. First, the interfering beamforming matrix may not be signaled. Second, the eNB might pair the same two WTRUs over the whole frequency band and signal only one beamforming matrix for the interference. Third, the eNB may signal all interfering beamforming matrices. Finally, the beamforming vectors for the interfering WTRUs may be signaled with dedicated RSs. For example, if orthogonal RSs are used for two different WTRUs, then one WTRU may attempt to estimate the other WTRU's RS by using several detection mechanisms, for example a Minimum Mean Square Estimation-Successive Interference Cancellation (MMSE-SIC) technique.

If the interference is not signaled either in the control channel or by means of an orthogonal RSs, the MU-MIMO operation would be transparent to the WTRU. CQI computation also may take into account the existence of an interfering WTRU. These techniques may also be applied to multi-cell MIMO where each antenna array group may belong to a different eNB.

FIG. 7 is a flow diagram of a sixth embodiment that employs non-codebook based beamforming. In this non-codebook based method for implementing beamforming, an estimate of the long term statistics of the channel is determined and used. In this example, a beamforming codebook is not required at the eNB. The eNB estimates the correlation of the channels from the uplink transmission 710. For example, the eNB estimates R₁=E (H₁^{H}H₁) and R=E (H₂^{H}H₂). Accordingly, the eigenvectors of the correlation matrices corresponding to the largest eigenvalues are used as the beamforming vectors w₁ and w₂.

When a non-codebook based beamforming approach is used, the beamforming vectors are signaled using dedicated RSs 720. This is achieved by transmitting w₁p₁ and w₂p₂ from the two antenna array groups on certain subcarriers where p₁ and p₂ are known RSs. Transmitting the dedicated RS from one or some of the antennas in a group is also possible if the phases and amplitudes of the channels from different antennas are similar.

The dedicated RSs from different antenna groups may be multiplexed over the OFDM symbols by using frequency division multiplexing (FDM), code division multiplexing (CDM), or time division multiplexing (TDM), or a combination of these 830. In FDM, different RSs are transmitted on different subcarriers. In CDM, different RSs are transmitted on the same subcarriers by using orthogonal spreading codes. If the reference signals p₁ and p₂ are already orthogonal, then spreading may also be used. In TDM, different RSs are transmitted on different subcarriers. The locations of the RSs in (frequency, time, code) domains are predetermined and known both to the WTRUs and the eNB.

If precoding is also used, the proper P may either be computed by the eNB or fed back by the WTRU to the eNB. If the eNB computes the P, it may be included in the effective channel and signaled in the dedicated RS. If the WTRU selects the appropriate P from a codebook, the procedure is the same as above, except in this case the channel is estimated from the dedicated RS.

The computed eigenvectors may be assumed to represent the effective channel, i.e. Hₑ=[v₁ v₂], where v₁ is the eigenvector of the i'th correlation matrix. Then, w₁ and w₂ may also be designed according to some optimal criteria, such as maximum SINR per beam, or MMSE per beam, etc. The methods that use dedicated RSs may also be used when codebook based beamforming is used as described above.

When multiple users are supported, the beamforming vectors may be designed such that inter-user interference is minimized. For example, a zero-forcing based approach may be used such that interuser interference is canceled. As an example, let us denote the effective channels for WTRU1 and WTRU2 may be denoted as Hₑ₁=[v₁₁ v₁₂] and Hₑ₂=[v₂₁ v₂₂], where vᵢⱼ denotes the eigenvector of the correlation of the channel matrix from the i'th antenna group to the j'th WTRU. This allows for the designing of beamforming matrices using a block diagonalization approach. Once the beamforming matrices are computed, they may be signaled with dedicated RSs. When multiple WTRUs are supported for beamforming, the eNB may choose to signal the beamforming matrix of the interfering WTRU or not.

Alternatively, control channel transmission with beamforming and space/frequency block coding may be used such that the WTRU estimates the long-term channel statistics and feeds back the eigenvectors of the channel correlation matrices. In this alternative method, a channel quantization codebook is used and the rest of the procedures are similar to those disclosed above.

In the current LTE architecture, control data is interleaved over the whole frequency band to achieve diversity. In addition to this, space/frequency coding is applied to improve the link reliability.

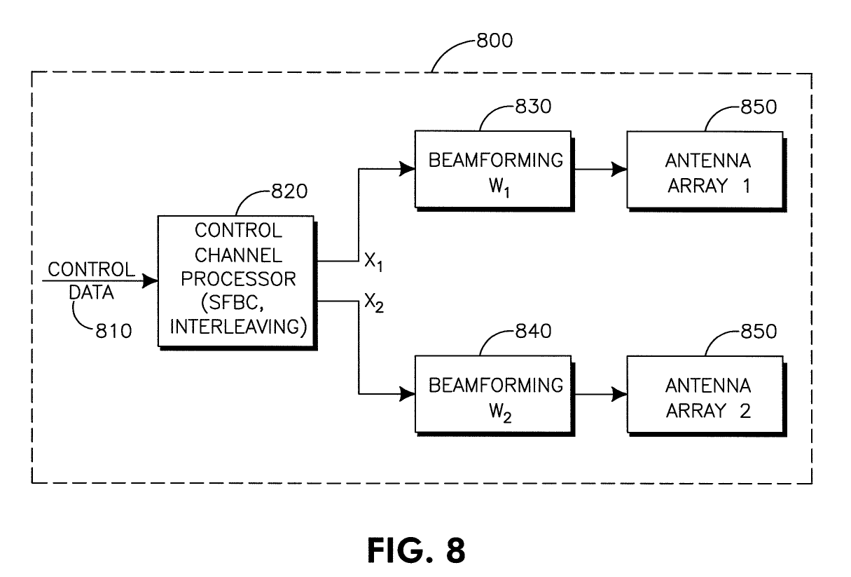

When there are closely spaced antennas, beamforming may also be used to transmit the control channel data using antenna array groups. FIG. 8 is a functional flow diagram of an example system for beamforming control data.

For example, the control data 810 is first processed such that interleaving and space time/frequency coding are applied at the control channel processor 820. Then, each output stream is multiplied by the corresponding beamforming vector, w1 830 and w2 840, respectively. If the beamforming vector is not reliable, then the eNB selects to not apply any beamforming weight. In this example, the control data is transmitted from one or more of the antenna ports in each of the antenna array groups 850. Common RSs are also transmitted from these antenna ports for control channel decoding. Control information may be transmitted on a different set of OFDM symbols and is meant to be readable by all WTRUs, therefore common RSs may be used as a demodulation reference for control.

If codebook based beamforming is used, then the same selected beamforming vectors are also used for the control channel. Control data is transmitted before the regular data. The first three OFDM symbols may be used for transmitting control data. Therefore, to prevent decoding delay, dedicated RSs are transmitted before data so that the WTRU may estimate the effective channel and decode the control data. When only data is beamformed, the dedicated RSs are transmitted on the RBs allocated to the WTRU, so the WTRU knows where to find them. The WTRU does not know where to look for the dedicated RSs because, when a non-codebook based beamforming is used, the control data is spread over the whole frequency band.

In a first example, the locations of the dedicated RSs are fixed and the WTRU tries each of the RSs until the decoding of the control channel is successful. This method results in an increase in the number of blind detections required for control channel decoding. In a second example, the locations of the dedicated RSs are fixed and the eNB informs the WTRU of the location of the dedicated RS with higher layer signaling. In a third example, the locations of the dedicated RSs are fixed and there is an implicit mapping to the location of the dedicated RS. In a fourth example, the control data of the initial transmission is not precoded and dedicated RSs are transmitted in the data region. The WTRU computes the beamforming vectors from the dedicated RSs. Then, during the consecutive transmissions, the same beamforming vectors are also used to precode the control data as well.

Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components, such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for beamforming at an evolved Node B (eNB) using antenna groups, the method comprising:
precoding a plurality of data streams;
beamforming each of the data streams, wherein the beamforming comprises selecting a beamforming vector from a codebook such that one beamforming vector is selected per antenna array group;
providing each of the beamformed data streams to one of a plurality of antenna array groups; and
transmitting an antenna configuration from at least one of the plurality of antenna array groups.

2. The method of claim 1, wherein the plurality of beamformed data streams are intended for a single wireless transmit/receive unit (WTRU).

3. The method of claim 1, wherein the plurality of beamformed data streams are intended for different wireless transmit/receive units (WTRUs).

4. The method of claim 1, wherein the beamforming comprises selecting a beamforming matrix from a codebook such that one column or row of the beamforming matrix is used as a beamforming vector per antenna array group.

5. The method of claim 1 further comprising:
receiving an indication of a preferred vector for selecting a beamforming vector.

6. The method of claim 1 further comprising:
receiving an indication of a preferred matrix for selecting a beamforming matrix.

7. The method of claim 1 further comprising:
receiving at least one of a beamforming vector index per antenna group, a beamforming matrix index, a precoding matrix index, a rank indicator, or a channel quality indicator (CQI).

8. The method of claim 1 further comprising:
transmitting a plurality of symbols from the plurality of data streams on different beams in a cyclical manner, wherein the plurality of symbols include at least one of a modulation symbol, an orthogonal frequency division multiplexing (OFDM) symbol, or a time slot.

9. The method of claim 1, wherein the at least one of the plurality of antenna array groups is configured semi-statistically for data transmission.

10. A method for beamforming at a wireless transmit/receive unit (WTRU) using antenna groups comprising:
receiving a common reference signal (CRS) and an antenna configuration;
estimating channels based on the CRS and antenna configuration;
selecting beamforming vectors for a plurality of antenna array groups, wherein the selecting the beamforming vectors is performed using a different codebook for each of the plurality of antenna array groups on a condition the each of the plurality of antenna array groups comprises a different number of antennas; and
transmitting an index of the beamforming vectors.

11. The method of claim 10, wherein an index of a preferred antenna array group is transmitted with the index of the beamforming vectors.

12. The method of claim 10 further comprising:
transmitting at least one of a beamforming vector index per antenna group, a beamforming matrix index, a precoding matrix index, a rank indicator, or a channel quality indicator (CQI).

13. An evolved Node B (eNB) comprising:
a processor configured to precode a plurality of data streams, beamform each of the data streams such that one beamforming vector is selected per antenna array group, and provide each of the beamformed data streams to one of a plurality of antenna array groups; and
a transmitter configured to transmit an antenna configuration from at least one of the plurality of antenna array groups.

14. The eNB of claim 13, wherein the transmitter is configured to transmit consecutive symbols from the plurality of data streams on different beams in a cyclical manner.

15. The eNB of claim 13 further comprising:
a receiver configured to receive at least one of a beamforming vector index per antenna group, a beamforming matrix index, a precoding matrix index, a rank indicator, or a channel quality indicator (CQI).

16. A wireless transmit/receive unit (WTRU) comprising:
a receiver configured to receive an antenna configuration;
a processor configured to estimate channels based on the antenna configuration and select beamforming vectors for a plurality of antenna array groups using a different codebook for each of the plurality of antenna array groups on a condition the each of the plurality of antenna array groups comprises a different number of antennas; and
a transmitter configured to transmit an index of the beamforming vectors.

17. The WTRU of claim 16, wherein the processor is configured to select the beamforming vectors using a different codebook for each of the plurality of antenna array groups on a condition the each of the plurality of antenna array groups comprises a different number of antennas.

18. The WTRU of claim 16, wherein the transmitter is further configured to transmit at least one of a beamforming vector index per antenna group, a beamforming matrix index, a precoding matrix index, a rank indicator, or a channel quality indicator (CQI).

19. The WTRU of claim 16, wherein the processor is configured to estimate channels from each of the plurality of antenna array groups, select one beamforming vector per antenna array group based on the estimation, select a transmission rank, and determine a channel quality indicator (CQI), and wherein the transmitter is configured to transmit the beamforming vector, transmission rank, and CQI.

20. The WTRU of claim 16, wherein the processor is configured to estimate channels from each of the plurality of antenna array groups, select one beamforming matrix per antenna array group based on the estimation, select a transmission rank, and determine a channel quality indicator (CQI), and wherein the transmitter is configured to transmit the beamforming matrix, transmission rank, and CQI.
